(19) United States
(12) Patent Application Publication
(10) Pub. No.: US 2006/0250526 A1
(43) Pub. Date: Nov. 9, 2006

(54) Interactive video game system

(75) Inventors: Shin-Chien Wang, Taipei City (TW); Chia-Ching Chang, Taichung City (TW)

Correspondence Address: BACON & THOMAS, PLLC, 625 SLATERS LANE, FOURTH FLOOR, ALEXANDRIA, VA, 22314, US

(73) Assignee: Sunplus Technology CO., Ltd., Hsinchu (TW)

(21) Appl. No.: 11/149,362

(22) Filed: Jun. 10, 2005

(30) Foreign Application Priority Data
May 6, 2005 (TW) 094114726

(51) Int. Cl. A63F 9/24; H04N 5/21; H04N 9/64; H04N 9/77; H04N 5/14; G06F 17/00; G06F 19/00; A63F 13/00

(52) U.S. Cl. 348/631; 463/1; 348/571; 348/663

(57) ABSTRACT

An interactive video game system. An image input device produces consecutive images including a participant in a field of view. A luminance processing device obtains a luminance change of a current image in accordance with the consecutive images, wherein the luminance change indicates an active region of the participant. A field hit checker and a motion detector check if the active region ranges in a digital region or compute a motion and direction of the active region in accordance with the luminance change of the current image and a digital information, thereby generating an output signal. A rendering engine controls a sprite image in accordance with the output signal and accordingly displays the result on a display. Thus, the participant can play an interactive video game.

### BACKGROUND OF THE INVENTION

1. Field of the Invention

The invention relates to the technical field of game system and, more particularly, to an interactive video game system.

2. Description of Related Art

FIG. 1 is a schematic view of a typical game system disclosed in U.S. Pat. No. 5,534,917. As shown, the system includes a video camera 102, a video digitizer 110, a computer 112, a video game 113 and a display 114. A background 104 is implemented along a Z-axis in a field of view 106 of the video camera 102. A participant 108 locates between the background 104 and the video camera 102 and within the field of view 106 of the video camera 102. The video digitizer 110 converts consecutive images produced by the video camera 102 into digital information and sends it to the computer 112.

FIG. 2 is a block diagram of a portion of the computer 112. The video camera 102 produces the images including the participant 108 and the background 104. The images are converted by the video digitizer 110 into the digital information. The video digitizer 110 separates the participant 108 from the background 104 and stores the digital information of the participant 108 in a video RAM 120. The computer 112 performs an operation of AND function 154 on the digital information of the participant 108 and bitmaps 144, 146, 148 pre-stored in a memory 116 in order to determine if a portion of the participant 108 locates in an interesting region. If the portion of the participant 108 locates in the interesting region, a control signal is generated. The control signal is output to a corresponding controller for playing an interactive video game. However, because the video digitizer 110 cannot separate the participant 108 from the background 104 effectively, the digital information of the participant 108 still has a lot of information of the background 104. Such information of the background 104 can affect the operation of AND function 154 to thus generate operation mistakes. To overcome this, the background 104 is typically limited to a single color (e.g., blue) to thus improve the performance of separating the participant 108 from the background 104. However, in this case, when the participant 108 dresses bluish clothes, the video digitizer 110 cannot effectively separate the participant 108 from the background 104 again.

Therefore, it is desirable to provide an improved system to mitigate and/or obviate the aforementioned problems.

### SUMMARY OF THE INVENTION

The object of the invention is to provide an interactive video game system, which can avoid the operation mistakes caused by the prior problem that the participant cannot effectively be separated from the background, thereby improving the reality of interactive game.

In accordance with one aspect of the present invention, there is provided an interactive video game system. The system includes an image input device, a memory, a luminance processing device, a field hit checker and a rendering engine. The image input device produces consecutive images including a participant in a field of view and accordingly outputs digital images. The memory is connected to the image input device to store sampled luminance data of a previous image (K−1) produced by the image input device, and pre-stores digital information of two or more objects in the field of view, for one digital information as a background image and a different one as a sprite image. The luminance processing device is connected to the image input device and the memory to perform an image processing on sampled luminance data of a current image (K) produced by the image input device and the sampled luminance data of the previous image stored in the memory, thereby obtaining a luminance change of the current image and storing the luminance change in the memory, wherein the luminance change indicates an active region of the participant. The field hit checker is connected to the memory to check if the active region is in a digital region of the sprite image in accordance with the luminance change of the current image and the pre-stored digital information. If the active region is in the digital region of the sprite image, the field hit checker produces a first output signal. The rendering engine is connected to the field hit checker to control the sprite image in accordance with the first output signal and to produce a corresponding image signal for a display to display.

In accordance with another aspect of the present invention, there is provided an interactive video game system. The system includes an image input device, a memory, a luminance processing device, a motion detector and a rendering engine. The image input device produces consecutive images including a participant in a field of view and accordingly outputs digital images. The memory is connected to the image input device to store sampled luminance data of a previous image produced by the image input device, and pre-stores digital information of two or more objects in the field of view, for one digital information as a background image a different one as a sprite image. The luminance processing device is connected to the image input device and the memory to perform an image processing on sampled luminance data of a current image produced by the image input device and the sampled luminance data of the previous image stored in the memory, thereby obtaining a luminance change of the current image and storing the luminance change in the memory, wherein the luminance change indicates an active region of the participant. The motion detector is connected to the memory to compute a motion and direction of the active region in accordance with the luminance change of the current image and the pre-stored digital information, thereby producing a second output signal. The rendering engine is connected to the motion detector to control the motion and direction of the sprite image in accordance with the second output signal and to produce a corresponding image signal for a display to display.

In accordance with a further aspect of the present invention, there is provided an interactive video game system. The system includes an image input device, a memory, a luminance processing device, a field hit checker, a motion detector and a rendering engine. The image input device produces consecutive images including a participant in a field of view and accordingly outputs digital images. The memory is connected to the image input device to store sampled luminance data of a previous image produced by the image input device, and pre-stores digital information of two or more objects in the field of view, for one digital information as a background image and a different one as a sprite image. The luminance processing device is connected to the image input device and the memory to perform an image processing on sampled luminance data of a current image produced by the image input device and the sampled luminance data of the previous image stored in the memory, thereby obtaining a luminance change of the current image and storing the luminance change in the memory, wherein the luminance change indicates an active region of the participant. The field hit checker is connected to the memory to check if the active region is in a digital region of the sprite image in accordance with the luminance change of the current image and the pre-stored digital information. If the active region is in the digital region of the sprite image, the field hit checker produces a first output signal. The motion detector is connected to the memory to compute a motion and direction of the active region in accordance with the luminance change of the current image and the pre-stored digital information, thereby producing a second output signal. The rendering engine is connected to the field hit checker and the motion detector to control the sprite image in accordance with the first and second output signals and to produce a corresponding image signal for a display to display.

Other objects, advantages, and novel features of the invention will become more apparent from the following detailed description when taken in conjunction with the accompanying drawings.

### BRIEF DESCRIPTION OF THE DRAWINGS

FIG. 1 is a schematic view of a prior art interactive video game system;

FIG. 2 is a block diagram of a portion of the system shown in FIG. 1;

FIG. 3 is a schematic view of an interactive video game system in accordance with the invention;

FIG. 4 is a block diagram of a processing system in accordance with the invention;

FIG. 5 is a schematic view of an operation of a field hit checker in accordance with the invention;

FIG. 6 is a flowchart of a motion detector in accordance with the invention;

FIG. 7 is a schematic view of a detection window and a luminance change table in accordance with the invention;

FIG. 8 is a pHit table in accordance with the invention;

FIG. 9 is a schematic view of a table of corresponding directions to detection points in accordance with the invention;

FIG. 10 is a schematic view of a dir_weight table used for calculating direction weight in accordance with the invention;

FIG. 11 is a schematic view of a table of corresponding motion vector directions to detection points of an active region for calculating a motion vector in accordance with the invention; and

FIG. 12 is a schematic view of an output of a display in accordance with the invention.

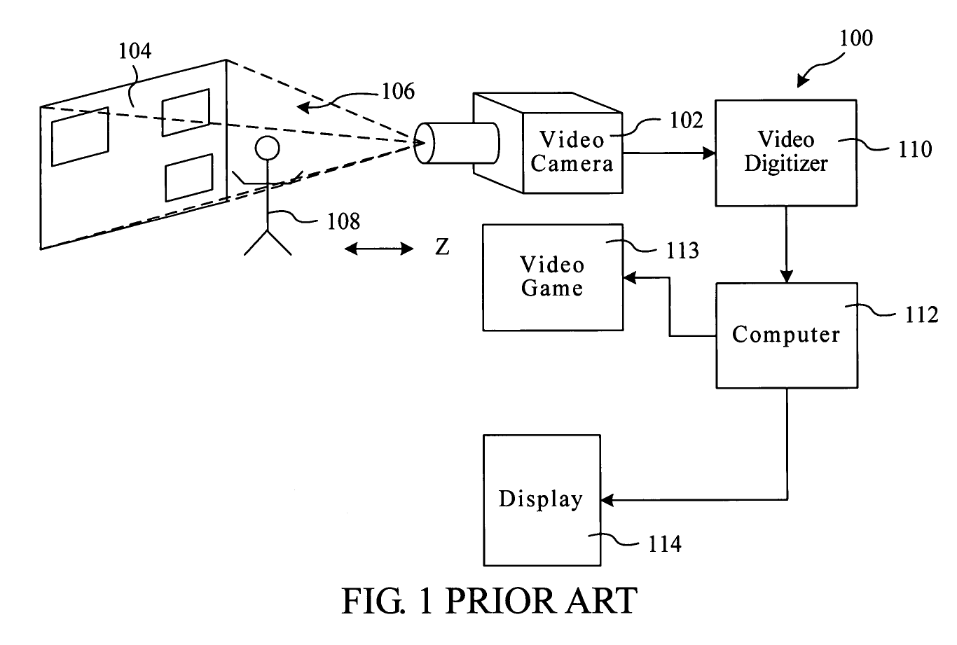

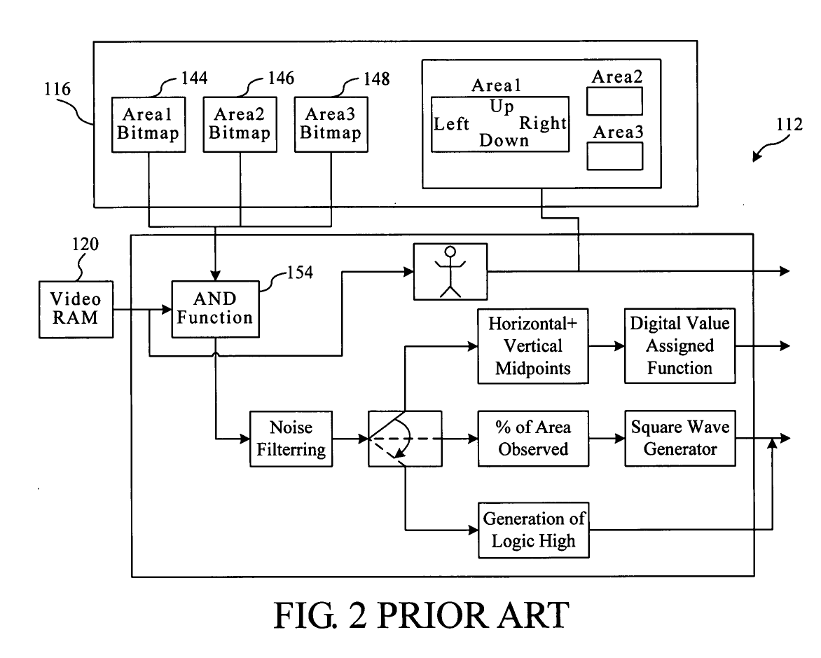

### DETAILED DESCRIPTION OF THE PREFERRED EMBODIMENT

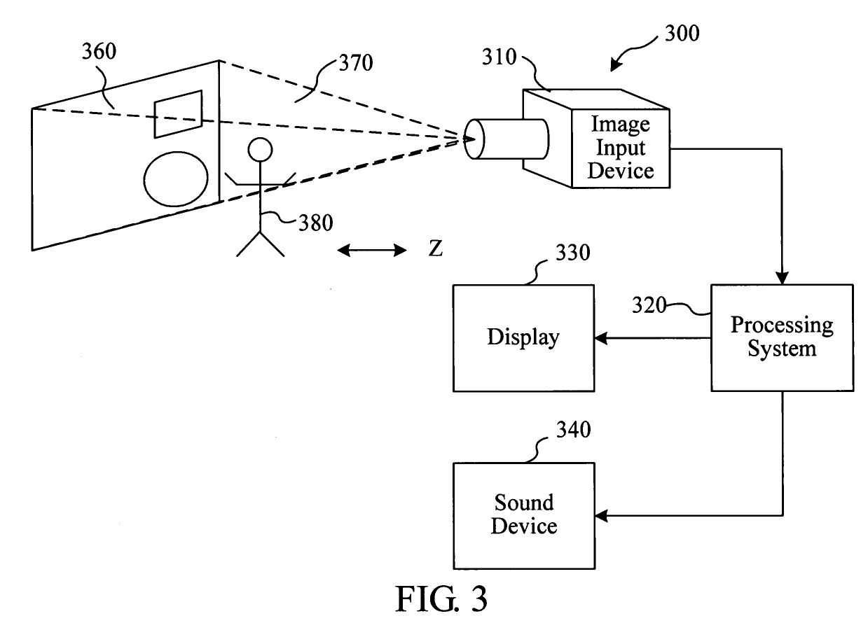

FIG. 3 is a block diagram of an interactive video game system 300 in accordance with the invention. The system 300 includes an image input device 310, a processing system 320, a display 330 and a sound device 340. An environmental background 360 locates on an axis Z which is in the field of view 370 of the image input device 310 and spaces a distance from the image input device 310. A participant 380 locates in the field of view 370 between the environmental background 360 and the image input device 310.

The image input device 310 produces consecutive images including a participant and accordingly outputs digital images with 640×480 YCbCr format. However, the digital images can be represented by other color models such as RGB, or by other resolutions such as 800×600. The image input device 310 can have a frame rate such as 30 or 25 frames per second, or other frame rates.

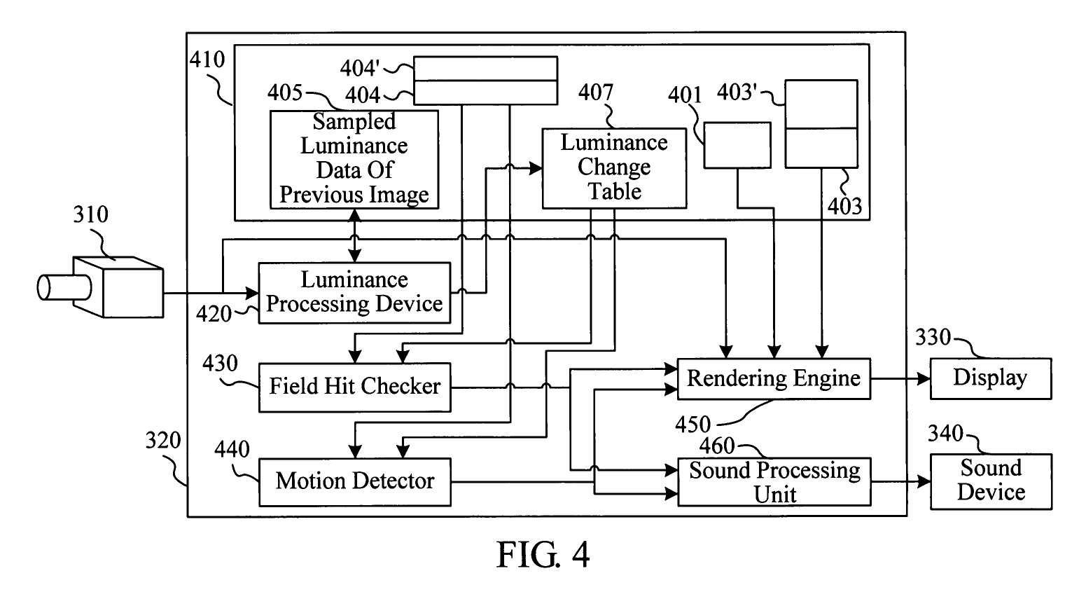

FIG. 4 is a block diagram of the processing system 320 in accordance with the invention. As shown in FIG. 4, the system 320 includes a memory 410, a luminance processing device 420, a field hit checker 430, a motion detector 440, a rendering engine 450 and a sound processing unit (SPU) 460.

The memory 410 is connected to the luminance processing device 420 to store sampled luminance data of a previous image (K−1) produced by the image input device 310, and pre-stores digital information of two or more objects in the field of view 370. One digital information is a background image 401 corresponding to the environmental background 360 and a different one digital information includes a sprite image 403 and a rectangular coordinate 404. The sprite image 403 is located in a rectangle specified by the coordinate 404. The sprite image 403 is a small movable and deformable image such as a drum, a gopher or a ball, depending on the applications. The sprite image 403 further includes an image 403′ associated with the deformed sprite image 403. For example, in a hit gopher game application, the associated image 403′ is an image generated when a gopher is hit. The rectangular coordinate 404 is represented by {(x1,y1),(x2,y2)}, which is a coordinate of the rectangle including the sprite image 403. The rectangular coordinate 404 further includes a rectangular coordinate 404′ that is represented by {(x1′,y1′), (x2,y2′)}. The rectangular coordinate 404′ is a coordinate of a rectangle including the associated image 403′.

The luminance processing device 420 is connected to the image input device 310 and the memory 410 to perform an image processing on luminance of a current image K produced by the image input device 310 and of the previous image K−1 stored in the memory 410. Then, the luminance processing device 420 generates a luminance change table 407 with respect to the current image K and stores the luminance change table 407 in the memory 410, wherein the luminance change table 407 indicates an active region of the participant 380.

The luminance processing device 420 performs a sampling procedure on the current image K outputted by the image input device 310. The sampling procedure samples a luminance Y of the current image K by 16×16, i.e., selecting one every 16 luminance data on X-axis and Y-axis, and discarding the remaining. Accordingly, for a 640×480 current image K, a 40×30 sampled luminance data can be obtained. However, 8×8 or 4×4 sampling procedure can be applied in other embodiments, or the luminance Y data of the current image K is directly used, without sampling.

The sampled luminance data of the current image K is compared with the sampled luminance data 405 of the previous image K−1, which is stored in the memory 410, to thus obtain the luminance change table 407 with respect to the current image K. The luminance processing device 420 subtracts each sampled luminance data of the current image K from a corresponding sampled luminance data of the previous image K−1 to thus obtain a subtracted result. Then, the subtracted result is compared with a first threshold. If the subtracted result is greater than or equal to the first threshold, a corresponding bit in the luminance change table 407 is set to one; otherwise, zero.

The luminance change table 407 has 40×30×1 (=1200) bits, each corresponding to a luminance change of a 16×16 block in the current image K. Accordingly, when a bit has a value as one, it indicates that an image change between two 16×16 block of the current image K and the previous image K−1 that correspond to the bit. Therefore, the luminance change table 407 represents an active region of the participant 380. The luminance processing device 420 stores the luminance change table in the memory 410 and replaces the sampled luminance data 405 of the previous image K−1 with the sampled luminance data of the current image K for storing in the memory 410.

The field hit checker 430 is connected to the memory 410 to check if the active region is in a digital region of the sprite image in accordance with the luminance change table 407 of the current image K and the pre-stored digital information. If the active region is in a digital region of the sprite image, the field hit checker 430 produces a first output signal.

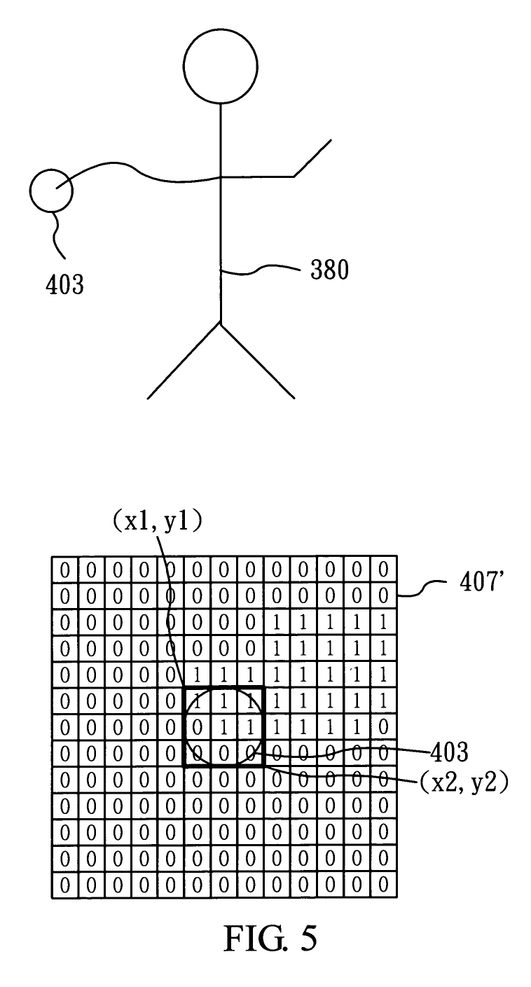

The field hit checker 430 counts the luminance change table 407 in the rectangular coordinate 404 for obtaining the number of bits with one. As shown in FIG. 5, number 407′ indicates a portion of the luminance change table 407, and the sprite image 403 is a ball. A rectangle including the sprite image 403 is represented by the rectangular coordinate 404, i.e., {(x1,y1),(x2,y2)}. If the luminance change table 407 in the rectangle has five bits as one, it indicates that there are five 16×16 blocks of the current image K in the digital region of the sprite 403. If the number is greater than or equal to a second threshold, it indicates that an active region of the participant 380 is in the digital region of the sprite. The second threshold is a positive integer. A special procedure is used to check if a part of the active region is in the digital region of the sprite, but not limited to this, a person skilled in the prior art can develop an equivalent procedure or the like.

In addition, in other embodiments, when the memory 410 stores a plurality of sprite images and associated rectangular coordinates, the field hit checker 430 sequentially checks if a part of the active region is in the digital regions of the sprite images; if yes, a corresponding output signal is produced. In general, the active region corresponds to the arms of the participant 380. To simplify the counting, a partial active region (such as the upper of the active region) corresponding to a palm of the participant 380 is checked.

The rendering engine 450 is connected to the memory 410 and the field hit checker 430 to control at least one object in accordance with the first output signal, and to produce a corresponding image signal for the display 330 to display. The sound processing unit 460 is connected to the field hit checker 430 to produce a sound signal in accordance with the first output signal for driving the sound device 340.

When rendering, the rendering engine 450 performs alpha blending on the background image 401 in the memory and the image produced by the image input device 310, wherein the alpha coefficient are adjustable. In this case, the alpha coefficient equals to 0.5. Then, the sprite image 403 is superimposed on the image after the alpha blending. In other embodiments, when rendering, the rendering engine 450 can superimpose the sprite image 403 on the background image 401 first and then perform the alpha blending on the image produced by the input device 310 and the image superimposed.

The rendering engine 450 controls the sprite image 403 in accordance with the first output signal. For example, if the sprite image 403 is a gopher, the field hit checker 430 produces the first output signal to indicate that an active region of the participant 380 is in the digital region of the sprite (gopher), i.e., the participant 380 hits on the gopher. The rendering engine 450 produces the image 403′ to represent and display the gopher hit on the display 330. In this case, the sound processing unit 460 produces a hit sound signal (such as a “slap”) to drive the sound device 340. The participant 380 accordingly plays the interactive video game through the display 330 and the sound device 340.

The motion detector 440 is connected to the memory 410 to compute a motion and direction of the active region in accordance with the luminance change table 407 of the current image K and the digital information pre-stored, thereby producing a second output signal.

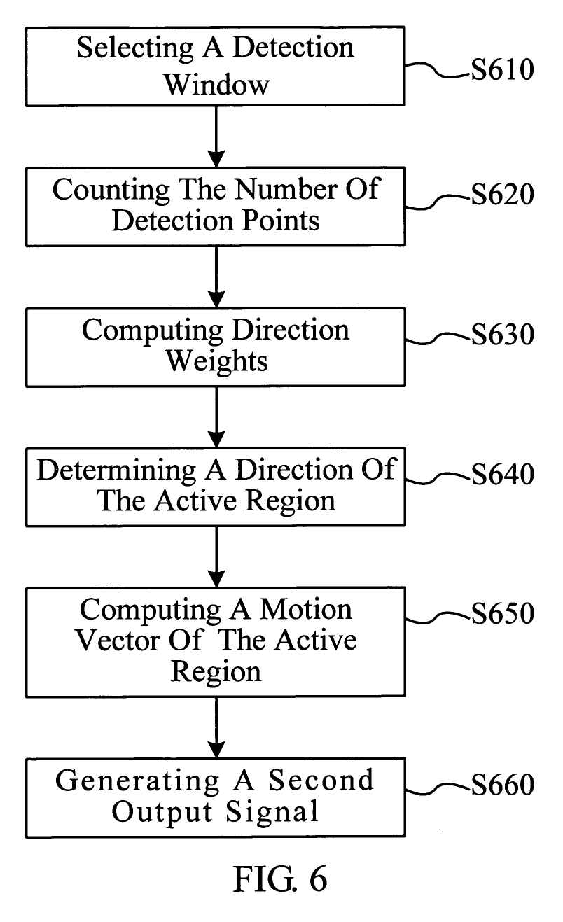

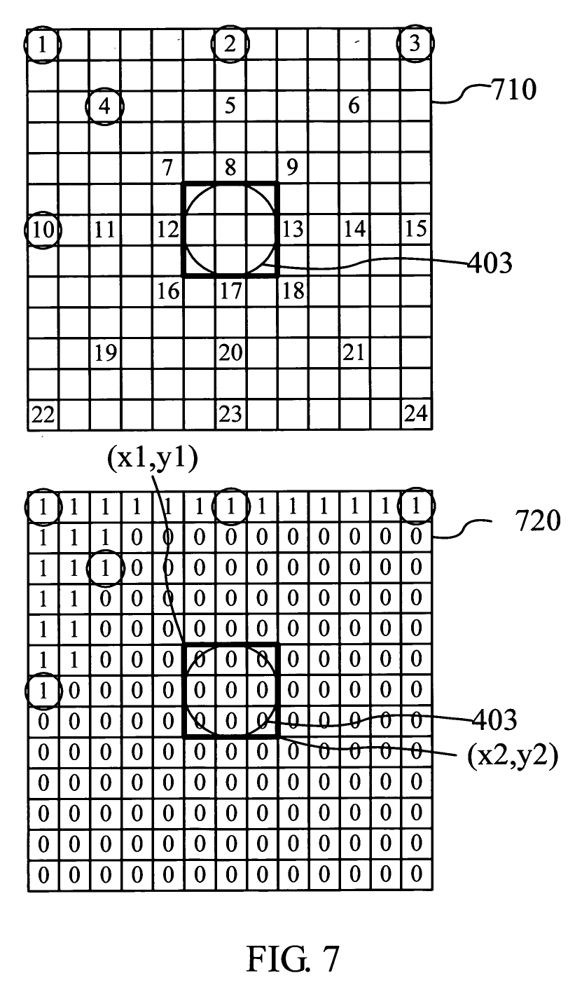

FIG. 6 is a flowchart of the motion detector 440 in accordance with the invention. As shown, in step S610, the motion detector 440 selects a detection window 710. The motion detector 440 uses the rectangular coordinate 404 and selects a 13×13 bit size as the detection window 710. FIG. 7 illustrates the detection window 710 and the luminance change table 407. As shown in FIG. 7, the detection window 710 has 24 check points, denoted by numbers 1-24. The motion detector 440 uses the rectangular coordinate 404 and selects a 13×13 bit size from the luminance change table 407 as a detection target 720. The motion detector 440 uses a special procedure to compute the motion and direction of the active region, but not limited to this, a person skilled in the prior art can develop an equivalent step or the like.

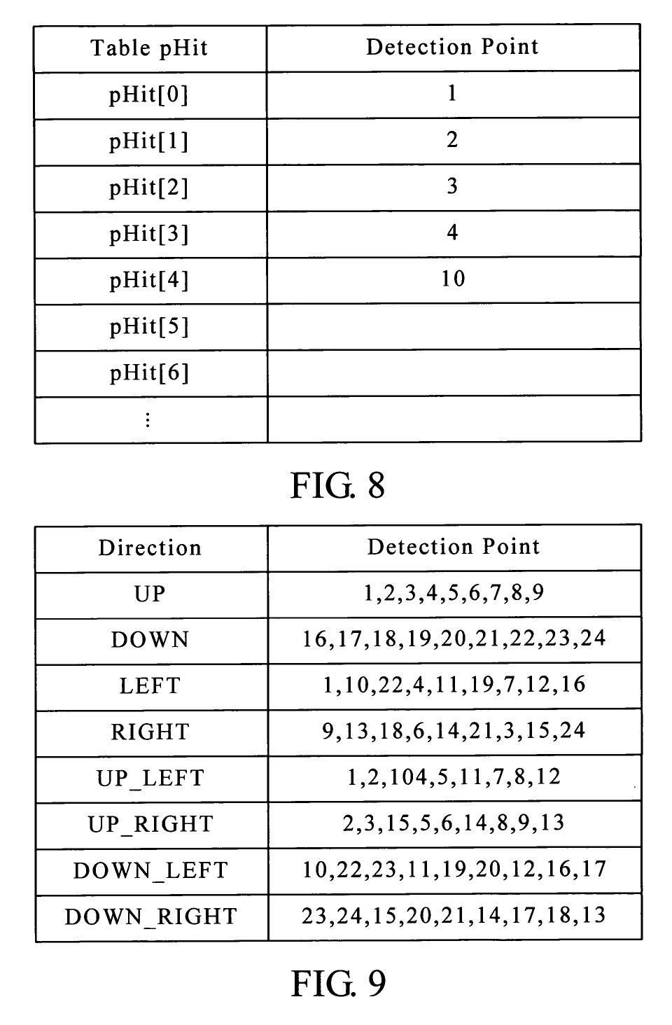

In step S620, it counts the number of detection points corresponding to bits with one. As shown, the detection points 1, 2, 3, 4, 10 have corresponding bits with one in the detection target 720, which are recorded in a pHit table of FIG. 8. As shown in FIG. 8, the detection points are recorded as pHit[0]=1, pHit[1]=2, pHit[2]=3, pHit[3]=4 and pHit[4]=10.

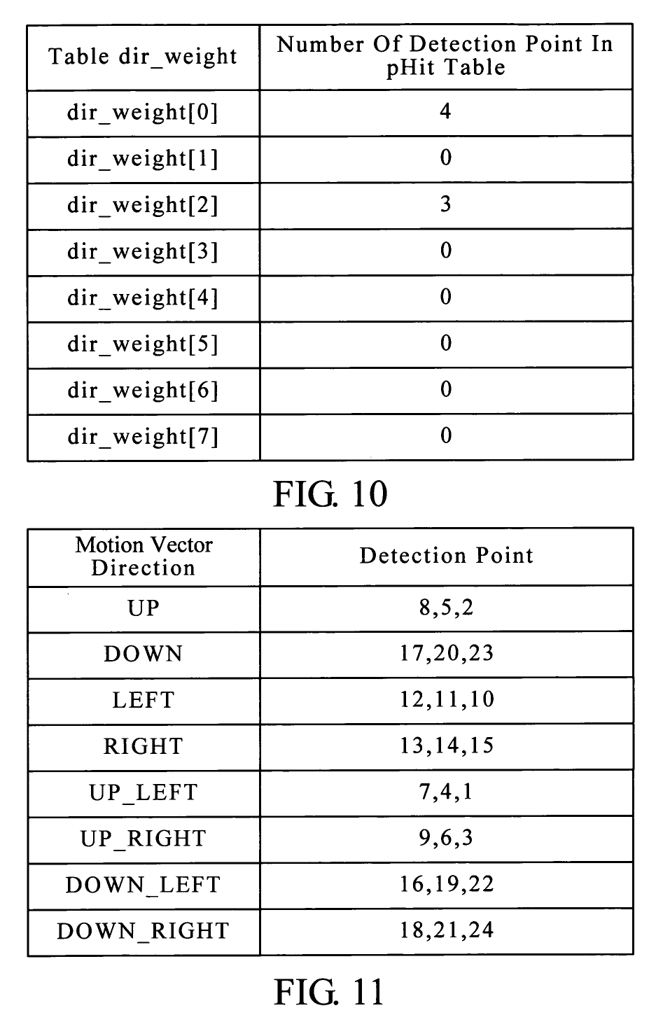

Step S630 computes direction weights, which counts the number of detection points in eight directions respectively based on the pHit table, and uses a dir_weight table to record the result. FIG. 9 is a table of corresponding directions to detection points in accordance with the invention, wherein an upper direction UP contains the detection points 1, 2, 3, 4, 5, 6, 7, 8 and 9, a left direction LEFT contains the detection points 1, 10, 22, 4, 11, 19, 7, 12 and 16, and so on. As shown in the dir_weight table of FIG. 10, since the detection points 1, 2, 3, 4, 10 corresponds to bits with one, the UP direction has a weight of four (the detection points 1, 2, 3 and 4) and thus a dir_weight[0] is set to 4. Similarly, a lower direction DOWN has a weight of zero (no detection point) and thus a dir_weight[1] is set to 0, and the LEFT direction has a weight of three (the detection points 1, 4 and 10) and thus a dir_weight[2] is set to 3. Accordingly, dir_weight[3] to dir_weight[7] have a weight of zero.

In step S640, it determines a direction of the active region, i.e., finding a direction corresponding to the most one among the dir_weight[0-7] as the direction of the active region. In this case, the dir_weight[0]=4 is the most one and thus the direction of the active region is determined as the UP direction.

Step S650 computes a motion vector of the active region, which counts the number of detection points along the direction of the active region in accordance with the result in step S640 and the pHit table. FIG. 11 is a table of corresponding directions to detection points of the active region in accordance with the invention. As shown, the UP direction has the detection points 8, 5 and 2, and so on. Since step S640 determines the direction of the active region as the upper region direction, the pHit table contains one detection point (detection point 2) in the UP direction, and the result is recorded in a parameter speed_weight. In this case, speed_weight is set to 1. If the pHit table contains {1, 2, 3, 4, 5, 6}, the pHit table contains two detection points (detection points 2, 5) in the UP direction, and in this case, speed_weight is set to 2. The motion detector 440 uses an equation speed_weight×speed_base+speed_offset to compute the motion vector of the active region. For example, when speed_base=1 and speed_offset=4, the motion vector of the active region is five (=1×1+4). Step S660 produces a second output signal, wherein the second output signal contains the direction and motion of the active region.

The rendering engine 450 is connected to the motion detector 430 to control a motion of the at least object in accordance with the second output signal and to produce a corresponding image signal for the display 330 to display. The sound processing unit 460 is connected to the motion detector 440 to produce a corresponding sound signal in accordance with the second output signal for driving the sound device 340.

The direction and motion vector of the active region in the second output signal represents a relative motion between the active region of the participant 380 and the sprite. Accordingly, the rendering engine 450 controls the motion of the sprite image 403 in accordance with the second output signal. For example, in a beach volleyball application, the sprite image 403 is a volleyball. When the second output signal indicates the UP direction and motion vector (5), the rendering engine 450 gradually changes a coordinate of the volleyball 403 and accordingly produces an associated image signal. Namely, for producing an image of frame K, the rendering engine 450 draws the volleyball 403 at coordinate (X, Y). Since the origin of display plane locates on the left upper corner, for producing an image of frame K+1, the rendering engine 450 draws the volleyball 403 at coordinate (X, Y −1×16), wherein ×16 indicates that the luminance processing device 420 performs a 16×16 sampling on the current image. For producing an image of frame K+5, the rendering engine 450 draws the volleyball 403 at coordinate (X, Y −5×16). The sound processing unit 460 produces a hit sound signal (such as a “slap”) to drive the sound device 340.

The processing system 320 can include both the field hit checker 430 and the motion detector 440, or either of them.

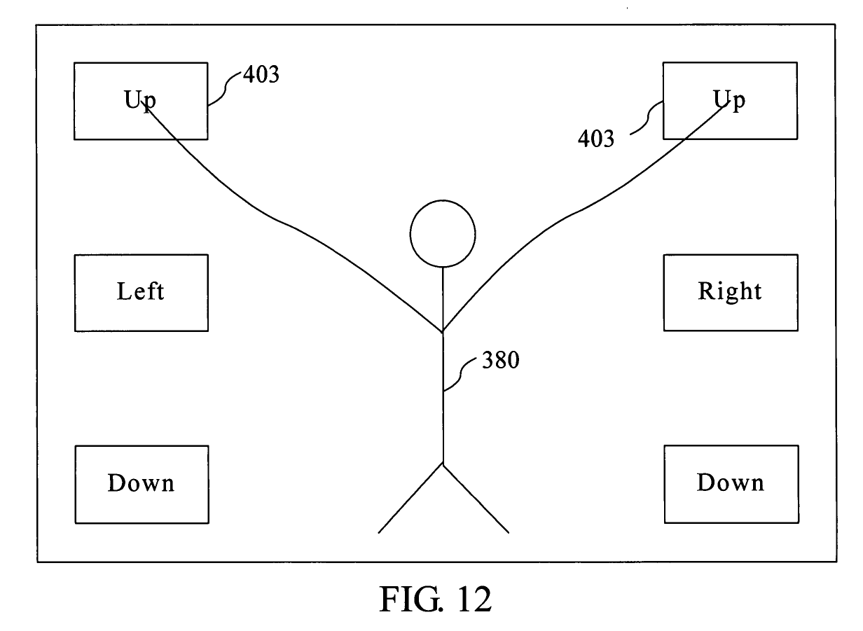

FIG. 12 is a schematic view of an output of the display 330, wherein the participant 380 stands in front of the environmental background 360 in the field of view 370. A portion of the participant 380, such as the arms, covers the digital region of the sprite image 430. In this case, the sprite image 403 is an upper button of a game. When the field hit checker 430 determines that a portion of the active region ranges in the digital region of the sprite, a corresponding first output signal is produced. The rendering engine 450 controls associated image in accordance with the upper button touched. Accordingly, the motion effect is achieved by using the field hit checker 430 only, and the participant 380 does not need to play the game using a physical joystick. As shown in the figure, the participant 380 covers the digital regions of two sprite image 403 with the hands in order to increase the accuracy.

In view of the foregoing, it is known that the environmental background 360 has no luminance change, the inventive luminance change table 407 can indicate the active regions of the participant 380. Thus, the prior problem that the participant cannot effectively be separated from the background is avoided. Further, the operation mistakes are reduced, and the reality of interactive game is increased.

Although the present invention has been explained in relation to its preferred embodiment, it is to be understood that many other possible modifications and variations can be made without departing from the spirit and scope of the invention as hereinafter claimed.

What is claimed is:

1. An interactive video game system, comprising:
an image input device, which produces consecutive images including a participant in a field of view and accordingly outputs digital images;
a memory, which is connected to the image input device to store a previous image produced by the image input device, and pre-stores digital information of two or more objects in the field of view;
a luminance processing device, which is connected to the image input device and the memory to perform an image processing on a current image produced by the image input device and the previous image stored in the memory, thereby obtaining a luminance change of the current image and storing the luminance change in the memory, wherein the luminance change indicates an active region of the participant;
a field hit checker, which is connected to the memory to check if the active region is in either digital region of the two objects in accordance with the luminance change of the current image and the pre-stored digital information, and if the active region is in either digital region, the field hit checker produces a first output signal; and
a rendering engine, which is connected to the field hit checker to control either image of the two objects in accordance with the first output signal and to produce a corresponding image signal for a display to display.

2. The system as claimed in claim 1, wherein the display is connected to the rendering engine to display the corresponding image signal and to provide visual feedback to the participant for interacting with either image of the two objects, thereby changing the first output signal.

3. The system as claimed in claim 1, further comprising a sound processing unit, which is connected to the field hit checker to produce a corresponding sound signal in accordance with the first output signal.

4. The system as claimed in claim 1, wherein one of the objects is a background image.

5. The system as claimed in claim 4, wherein a different one of the objects is a sprite image.

6. The system as claimed in claim 5, wherein the background image and one of the consecutive images produced by the image input device are processed by an alpha blending to thus produce a blending image.

7. The system as claimed in claim 6, wherein the sprite image is superimposed on the blending image.

8. The system as claimed in claim 1, wherein the memory stores luminance data of the previous image.

9. The system as claimed in claim 8, wherein the luminance data is sampling for reducing data amount.

10. An interactive video game system, comprising:
an image input device, which produces consecutive images including a participant in a field of view and accordingly outputs digital images;
a memory, which is connected to the image input device to store a previous image produced by the image input device, and pre-stores digital information of two or more objects in the field of view;
a luminance processing device, which is connected to the image input device and the memory to perform an image processing on a current image produced by the image input device and the previous image stored in the memory, thereby obtaining a luminance change of the current image and storing the luminance change in the memory, wherein the luminance change indicates an active region of the participant;
a motion detector, which is connected to the memory to compute a motion and direction of the active region in accordance with the luminance change of the current image and the pre-stored digital information, thereby producing a second output signal; and
a rendering engine, which is connected to the motion detector to control either motion and direction of the two objects in accordance with the second output signal and to produce a corresponding image signal for a display to display.

11. The system as claimed in claim 10, wherein the display is connected to the rendering engine to display the corresponding image signal and to provide visual feedback to the participant for interacting with either image of the two objects, thereby changing the second output signal.

12. The system as claimed in claim 10, further comprising a sound processing unit, which is connected to the motion detector to produce a corresponding sound signal in accordance with the second output signal.

13. The system as claimed in claim 10, wherein one of the objects is a background image.

14. The system as claimed in claim 13, wherein a different one of the objects is a sprite image.

15. The system as claimed in claim 14, wherein the background image and one of the consecutive images produced by the image input device are processed by an alpha blending to thus produce a blending image.

16. The system as claimed in claim 15, wherein the sprite image is superimposed on the blending image.

17. The system as claimed in claim 10, wherein the memory stores luminance data of the previous image.

18. The system as claimed in claim 17, wherein the luminance data is sampling for reducing data amount.

19. An interactive video game system, comprising:
an image input device, which produces consecutive images including a participant in a field of view and accordingly outputs digital images;
a memory, which is connected to the image input device to store a previous image produced by the image input device, and pre-stores digital information of two or more objects in the field of view;
a luminance processing device, which is connected to the image input device and the memory to perform an image processing on a current image produced by the image input device and the previous image stored in the memory, thereby obtaining a luminance change of the current image and storing the luminance change in the memory, wherein the luminance change indicates an active region of the participant;
a field hit checker, which is connected to the memory to check if the active region is in either digital region of the two objects in accordance with the luminance change of the current image and the pre-stored digital information, and if the active region is in either digital region, the field hit checker produces a first output signal;
a motion detector, which is connected to the memory to compute a motion and direction of the active region in accordance with the luminance change of the current image and the pre-stored digital information, thereby producing a second output signal; and
a rendering engine, which is connected to the field hit checker and the motion detector to control either of the two objects in accordance with the first and the second output signals and to produce a corresponding image signal for a display to display.

20. The system as claimed in claim 19, wherein the display is connected to the rendering engine to display the corresponding image signal and to provide visual feedback to the participant for interacting with either image of the two objects, thereby changing the first and the second output signals.

21. The system as claimed in claim 19, further comprising a sound processing unit, which is connected to the field hit checker and the motion detector to produce a corresponding sound signal in accordance with the first or second output signal.

22. The system as claimed in claim 19, wherein one of the objects is a background image.

23. The system as claimed in claim 22, wherein a different one of the objects is a sprite image.

24. The system as claimed in claim 23, wherein the background image and one of the consecutive images produced by the image input device are processed by an alpha blending to thus produce a blending image.

25. The system as claimed in claim 24, wherein the sprite image is superimposed on the blending image.

26. The system as claimed in claim 19, wherein the memory stores luminance data of the previous image.

27. The system as claimed in claim 26, wherein the luminance data is sampling for reducing data amount.
